(19) United States
(12) Patent Application Publication
(10) Pub. No.: US 2004/0239176 A1
(43) Pub. Date: Dec. 2, 2004

(54) Tandem master cylinder for electrohydraulic braking system

(76) Inventors: Nathalie Beccafico, Garges Les Gonesses (FR); Jean-Pierre Delage, Le Perreux Sur Marne (FR); Stephane Manfredini, Chatou (FR); Yanniok Nen, La Varenne St Hilaire (FR)

Correspondence Address: Leo H McCormick Jr, 2112 Mishawaka Avenue, PO Box 4721, South Bend, IN, 46634-4721, US

(21) Appl. No.: 10/490,576

(22) PCT Filed: Sep. 10, 2002
(86) PCT No.: PCT/FR02/03063

(30) Foreign Application Priority Data
Sep. 20, 2001 (FR) 01/12163

(51) Int. Cl. B60T 8/42

(52) U.S. Cl. 303/115.1

(57) ABSTRACT

The master cylinder comprises a body (12) defining a primary pressure chamber (14) and a secondary pressure chamber (16), separated by a secondary piston (20); means (24) for the hydraulic connection of the primary pressure chamber (14) with braking-force simulation means (26); moving and stationary means (28, 30) for the sealing of the hydraulic connection means (24) and borne by the secondary piston (20) and the body (12) respectively. The piston (20) is axially movable between a rest position, in which the moving and stationary sealing means (28, 30) are spaced apart from each other, and a position in which said moving and stationary sealing means (28, 30) are cooperating with each other. A moving stop (34) and a stationary stop (32), borne by the secondary piston (20) and the body (12) respectively, cooperate with each other so as to define, the rest position of the secondary piston (20). The relative axial position of the moving and stationary sealing means (28, 30) is adjusted when the secondary piston (20) is in its rest position, through the adjustment of the axial position of the stationary stop (32) in the body (12).

The present invention relates to an adjusting process for a tandem master cylinder intended for an electrohydraulic braking system, and it also deals with a pin for the implementation of said process, and with a tandem master cylinder for an electrohydraulic braking system.

A tandem master cylinder for an electrohydraulic braking system is already well known from the state of the art, such device being of the type comprising:

a body, defining primary and secondary pressure chambers, separated by an axially movable piston, the so-called secondary piston;

means for the hydraulic connection of the primary pressure chamber with braking-force simulation means;

complementary moving and stationary means for the sealing of the hydraulic connection means, and borne by the secondary piston and the body respectively, the secondary piston being axially movable between a rest position, in which the moving and stationary sealing means are spaced apart from each other, and a position in which these moving and stationary sealing means are cooperating with each other; and

complementary moving and stationary stops which cooperate with each other so as to define the rest position of the secondary piston, and which are borne by the secondary piston and the body, respectively.

Usually, the driver depresses a brake pedal, connected to a primary piston defining the primary pressure chamber, so as to control the braking of the vehicle, and the travel of the brake pedal is transmitted to a hydraulic braking circuit through various means.

A braking system, comprising a master cylinder of the above-mentioned type, is capable of operating in both normal and emergency configurations.

When the braking system is in a normal braking mode, the hydraulic braking circuit is isolated from the master cylinder and the travel of the brake pedal is transmitted to the hydraulic braking circuit through electrical means.

On the other hand, when the braking system is in the emergency braking mode, the hydraulic braking circuit is connected with the master cylinder and the travel of the brake pedal is transmitted to the hydraulic braking circuit through the brake fluid, contained inside said master cylinder.

Usually, the stationary sealing means comprise an annular bearing seat, provided in the body, and the moving sealing means comprise a O-ring borne by the secondary piston and intended for a cooperation with such bearing seat.

In the normal braking configuration of the braking system, when the driver depresses the brake pedal, such action results in a travel of the secondary piston through a short stroke and consequently the moving and stationary sealing means may remain spaced apart from each other and, therefore, the hydraulic connection means may remain in the open state.

In such a normal operating configuration, the simulation means give the driver, as he depresses the brake pedal, a braking feeling like that he would get in the emergency braking configuration, in which the master cylinder is connected with the hydraulic braking circuit.

In the emergency operating configuration of the braking system, the force exerted by the driver on the brake pedal results in a travel of the secondary piston through a long stroke, at the end of which the moving and stationary sealing means are cooperating with each other so as to close the hydraulic means connecting the primary pressure chamber with the braking-force simulation means.

During the long stroke of the piston, owing to the fact that the hydraulic connection means are not closed yet, some brake fluid is transferred from the primary pressure chamber into the simulation means. As a matter of fact, the smaller the quantity of brake fluid transferred to the simulation means, the faster the pressure rise in the primary pressure chamber, which means a more efficient braking operation.

The object of this invention is to limit as much as possible the stroke of the secondary piston when the driver depresses the brake pedal in an emergency braking configuration, so as to limit the quantity of brake fluid, which is transferred from the primary pressure chamber towards the braking-force simulation means.

To this end, a subject matter of the present invention is an adjusting process for a tandem master cylinder intended for an electrohydraulic braking system and of the type comprising:

a body, defining primary and secondary pressure chambers, separated by an axially movable piston, the so-called secondary piston;

means for the hydraulic connection of the primary pressure chamber with braking-force simulation means;

complementary moving and stationary means for the sealing of the hydraulic connection means, and borne by the secondary piston and the body respectively, the secondary piston being axially movable between a rest position, in which the moving and stationary sealing means are spaced apart from each other, and a position in which these moving and stationary sealing means are cooperating with each other; and

complementary moving and stationary stops, which cooperate with each other so as to define the rest position of the secondary piston, and which are borne by the secondary piston and the body, respectively,

characterised in that the relative axial position of the moving and stationary sealing means is adjusted, when the secondary piston is in its rest position, by an adjustment of the axial position of the stationary stop inside the body.

According to features of various embodiments of said process:

the master cylinder being of the type comprising a stationary pin, extending substantially transversely to the travel direction of the secondary piston in an elongate cavity provided in said piston, the moving and stationary stops being defined by complementary contact areas of the stationary pin and of the elongate cavity respectively, and the pin being accommodated inside a cylindrical hole provided in the body, having an axis which is substantially transverse to the travel direction of the secondary piston and called the reference axis, the axial position of the stationary stop inside the body is adjusted through the adjustment of the distance of the contact area of the pin relative to the reference axis;

the distance of the contact area of the pin relative to the reference axis is adjusted by means of a batch of at least two pins, each of them having a general form of revolution with a portion for a contact with the moving stop, and extending into at least one centering end received inside the hold-down hole, the diameters of the contact portions being different from a pin to another one, whereas the diameters of the centering ends are identical for all the pins;

the master cylinder is fitted with a pin belonging to the batch, called the reference pin;

the stroke of the secondary piston is measured between its rest position and the position in which the moving and stationary sealing means are cooperating with each other, such stroke being called the dead stroke;

the value of the measured dead stroke is compared with a desired predetermined value

the reference pin is replaced by another pin, which minimizes the difference between the measured and desired values of the dead stroke;

the diameter of the contact portion of the reference pin is the smallest in the batch so as to ensure a maximal dead stroke

the distance of the contact area of the pin relative to the reference axis is adjusted through a rotation about said reference axis of a portion of such pin, exhibiting a contour, for a contact with the moving stop, and evoluting about the reference axis like an eccentric or a cam;

the stroke of the secondary piston is measured between its rest position and the position in which the moving and stationary sealing means are cooperating with each other, such stroke being called the dead stroke;

the value of the measured dead stroke is compared with a desired predetermined value o the pin is moved about the Preference axis till it reaches an angular position, zeroing the difference between the measured and desired values of the dead stroke, such position being called the adjusted position;

prior to measuring the dead stroke of the secondary piston, the pin is set in a predetermined angular position about the reference axis, such position being called the pre adjustment position, in which the dead stroke is maximal;

once the pin has been moved to its adjusted position, such pin is locked in position in the hold-down hole, in particular through the fixing of one end of the pin inside the hold-down hole;

as regards the measurement of the dead stroke of the piston:

the secondary piston is set in its rest position;

the primary pressure chamber is supplied with pressure gas, more particularly air;

the secondary piston is moved to the position in which the moving and stationary means cooperate with each other;

the closing of the connection means is detected through a pressure change in the braking-force simulation means.

Another subject matter still of the present invention is a pin, characterised in that it is intended for the implementation of the above-defined process, or in that it belongs to a batch of pins for the implementation of the above-described process.

According to another aspect, the invention also relates to a tandem master cylinder for an electrohydraulic braking system, and of the type comprising:

a body, defining primary and secondary pressure chambers, separated by an axially movable piston, the so-called secondary piston;

means for the hydraulic connection of the primary pressure chamber with braking-force simulation means;

complementary moving and stationary means for the sealing of the hydraulic connection means, and borne by the secondary piston and the body respectively, the secondary piston being axially movable between a rest position, in which the moving and stationary sealing means are spaced apart from each other, and a position in which these moving and stationary sealing means are cooperating with each other; and

a pin

fixed inside a cylindrical hole provided in the body, having an axis substantially transverse to the travel direction of the secondary piston and called the reference axis, and

extending inside an elongate cavity provided in the secondary piston,

the stationary pin and the elongate cavity comprising complementary contact areas defining complementary stationary and moving stops, which cooperate with each other so as to define the rest position of the secondary piston,

characterised in that the contact area of the stationary pin is defined through a contour of said stationary pin, evoluting about the reference axis like an eccentric or a cam.

According to other features of such master cylinder:

the pin is fitted with means to be fixed inside the hold-down hole;

the stationary sealing means comprise an annular bearing seat provided in the body, and the moving sealing means comprise a O-ring, borne by the secondary piston and intended for a cooperation with said bearing seat;

the elongate cavity communicates with a brake-fluid supply chamber, called the secondary supply chamber, the secondary piston being provided with a passage connecting up the secondary supply and pressure chambers, and closable by a valve;

the valve is fitted with a control stem, extending through the passage provided in the secondary piston, and intended for a cooperation with the pin so as to keep the valve in the open position.

Other features and advantages of the present invention will be apparent from the following detailed description, by way of example and by no means as a limitation, when taken in conjunction with the accompanying drawings, in which:

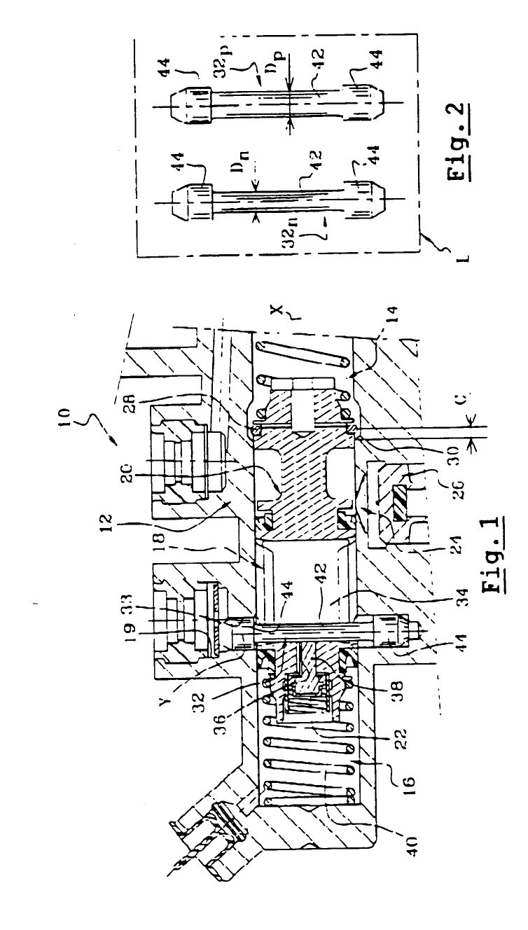

FIG. 1 is a partial axial sectional view of a tandem master cylinder for a braking system and intended to be adjusted using a process according to a first embodiment of the invention;

FIG. 2 is a view of a batch of pins, each one being represented in elevation, for the implementation of the adjusting process for the master cylinder shown in FIG. 1

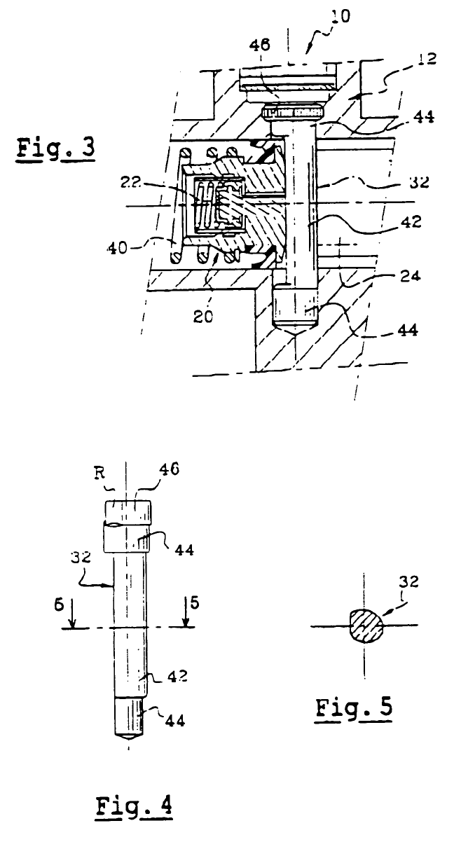

FIG. 3 is a view, similar to FIG. 1, of a tandem master cylinder for a braking system, intended to be adjusted using a process according to a second embodiment of the invention;

FIG. 4 is an elevation view of a variant of the pin of the master cylinder shown in FIG. 3; and

FIG. 5 is a sectional view along the line 5-5 in FIG. 4.

FIG. 1 shows a tandem master cylinder for an electrohydraulic braking system according to a first embodiment of the invention, said master cylinder being generally referred to by 10 as a whole. In the described example, the tandem master cylinder 10 is of the valved type.

The master cylinder 10 comprises a body 12 defining two brake-fluid pressurizing chambers, which are usually called the primary pressure chamber 14 and the secondary pressure chamber 16.

The body 12 also defines a supply chamber 18 for the secondary pressure chamber 16. Such chamber 18, usually called the secondary supply chamber, is connected to a brake-fluid tank (not shown) through conventional means 19.

The master cylinder 10 also comprises two pistons, namely a primary piston and a secondary piston. In a manner known per se, the primary piston (not shown) is connected to a brake pedal to be depressed by the driver. And the secondary piston 20 separates the primary pressure chamber 14 from the secondary pressure chamber 16.

Both pistons bear conventional primary and secondary valves. The secondary valve 22 alone is illustrated in FIG. 1.

The master cylinder 10 also comprises conventional means 24 for the hydraulic connection of the primary pressure chamber with conventional braking-force simulation means 26.

The hydraulic connection means 24 are closable using a O-ring 28, borne by the secondary piston 20 and intended for a cooperation with an annular bearing seat 30 provided in the body 12. The O-ring 28 and the bearing seat 30 are the respective complementary moving and stationary sealing means for the hydraulic connection means 24.

The secondary piston 20 is axially movable, parallel to the axis X represented in FIG. 1, between a rest position, in which the O-ring 28 and the bearing seat 30 are spaced apart from each other, and a position in which the O-ring 28 and the bearing seat 30 are cooperating with each other, with the result that the connection means 24 are closed.

The secondary piston 20 cooperates with a pin 32, which is rigidly locked with the body 12 and accommodated inside a cylindrical hole 33 provided in the body 12, and extending transversely on both sides of the secondary supply chamber 18. The axis of the hole 33 is substantially transverse to the travel direction of the secondary piston 20, such axis being called the reference axis Y.

The pin 32 extends substantially transversely to the travel direction of the secondary piston 20, inside an elongate cavity 34 provided in said piston 20.

The stationary pin 32 and the contour of the secondary piston 20, defining the elongate cavity 34, comprise complementary contact areas, which form complementary stationary and moving stops cooperating with each other so as to define the rest position of the secondary piston 20.

The elongate cavity 34 communicates with the secondary supply chamber 18. The latter is capable of being connected with the secondary pressure chamber 16 through a passage 36, closable by means of the secondary valve 22.

The secondary valve 22 is fitted with a control stem 38, extending through the passage 36 and intended for a cooperation with the pin 32 so as to keep the valve 22 in the open position, when the secondary piston 20 is in its rest position, as shown in FIG. 1.

Quite conventionally, the secondary piston 20 is resiliently returned to its rest position by means of a spring 40, called the secondary spring.

FIG. 2 shows a batch L comprising at least two pins 32ₙ, 32ₚ, each of them having a general form of revolution with a portion 42 for a contact with the contact area of the elongate cavity 34, said portion extending into at least one centering end 44 received inside the hold-down hole 33. In the illustrated example, each pin 32ₙ, 32ₚ comprises two centering ends 44. The diameters Dₙ, Dₚ of the contact portions 42 are different from a pin to another one, whereas the diameters D of the centering ends 44 are identical for all the pins.

In order to adjust the stroke of the secoyndary piston 20 between its rest position, as shown in FIG. 1, and the position in which the connection means 24 are closed (cooperation of the O-ring 28 with the bearing seat 30), such stroke being called the dead stroke C, the invention suggests that the distance of the contact area of the pin 32 be adjusted relative to the reference axis Y.

For this purpose, according to a first embodiment of the adjusting process for the master cylinder, this invention suggests using a batch of pins, like that shown in FIG. 2.

First of all, the master cylinder is fitted with a pin 32ₙ belonging to the batch, and called the reference pin. Said pin 32ₙ is e.g. identical with the pin 32 represented in FIG. 1. Preferably, the diameter Dₙ of the contact portion of the reference pin 32ₙ is the smallest in the batch so as to ensure a maximal dead stroke.

Then, the dead stroke of the secondary piston 20 is measured between its rest position and the position in which the O-ring 28 cooperates with the bearing seat 30, for instance in accordance with the following procedure.

Initially, the secondary piston 20 is set in its rest position as shown in FIG. 1, and the primary piston not been fitted yet inside the body 12 of the master cylinder.

Then, the primary pressure chamber 14 is supplied with pressure gas, more particularly air, and the secondary piston 20 is moved, against the resilient returning force of the spring 40, towards the position in which the O-ring 28 cooperates with the bearing seat 30.

Since the connection means 24 are in the open state, the pressure air, contained inside the primary pressure chamber 14, flows into the braking-force simulation means 26.

The pressure inside the braking-force simulation means 26 is measured by means of an adequate sensor. And a travel sensor is provided for the measurement of the travels of the secondary piston 20.

The secondary piston 20 is moved on forwards until the connection means 24 are closed through the cooperation of the O-ring 28 with the bearing seat 30. Such sealing is detected by the pressure sensor because a pressure change appears in the braking-force simulation means 26.

The dead stroke C is determined using the travel sensor for the secondary piston 20.

Once the dead stroke C of the secondary piston 20 has been measured, the value of this measured dead stroke is compared with a desired predetermined value. If there is a difference between these values, the reference pin 32ₙ is replaced by another pin 32ₚ, the contact portion 42 of which has a greater diameter Dₚ than that of the contact portion 42 of the reference pin, so as to minimize, or better still reduce to zero, the difference between the measured and desired values of the dead stroke C.

FIG. 3 shows a tandem master cylinder 10 for an electrohydraulic braking system according to the invention. In FIG. 3, the same reference numerals designate the same elements as those shown in the figures before.

In this instance, the contact area of the stationary pin 32 (forming the stationary stop defining the rest position) is defined by a contour of the contact portion 42 of said stationary pin 32, evoluting about the reference axis Y like an eccentric (pin 32 as illustrated in FIG. 3) or like a cam (a variant of the pin 32, represented in FIG. 4 and 5).

One of the centering ends 44 of the pin 32 is fitted with a fixing flange 46 to be received inside the hold-down hole 33. Such flange 46 may exhibit a peripheral fixing toothing, just like the pin 32 shown in FIG. 3.

According to a second embodiment of the adjusting process, suitable for the master cylinder according to FIG. 3, the invention suggests that the distance of the contact area of the pin 32 (forming the stationary stop, defining the rest position) be adjusted relative to the reference axis Y through a rotation, about said reference axis Y, of the portion 42 of such pin 32, exhibiting an evoluting contour.

Thus and first of all, the dead stroke C of the secondary piston 20 is measured between its rest position and the position in which the O-ring 28 and the bearing seat 30 are cooperating with each other, for instance using pressure gas as per the above-described procedure.

Preferably, prior to measuring the dead stroke of the secondary piston 20, the pin 32 is set in a predetermined angular position about the reference axis Y, such position being called the pre adjustment position, in which the dead stroke C is maximal. This pre adjustment position may be made visible, using guide marks, like the guide mark R provided on an end of the pin 32 as shown in FIG. 4.

Then the value of the measured dead stroke is compared with a desired predetermined value. If there is a difference between these values, the pin 32 is moved about the reference axis Y till it reaches an angular position, zeroing the difference between the measured and desired values of the dead stroke, such position being called the adjusted position.

Once the pin 32 has been moved to its adjusted position, such pin 32 is locked in position in the hold-down hole 33, in particular through the fixing of the flange 46 of said pin inside the hold-down hole 33.

Therefore, thanks to the invention, the relative axial position of the moving and stationary sealing means, 28 and 30 respectively, can be adjusted when the secondary piston 20 is in its rest position, through the adjustment of the axial position of the stationary pin (contact area of the stationary pin 32) inside the body 12.

Among the advantages afforded by this invention, it should be noted that the dead stroke of the secondary piston 20 can be easily adjusted and that, therefore, it is possible to limit the quantity of brake fluid, which is transferred from the primary pressure,.chamber 14 to the braking-force simulation means 26 when the driver depresses the brake pedal, as the braking system (including the master cylinder 10 according to the invention) is in the emergency operation configuration.

1. an adjusting process for a tandem master cylinder for an electrohydraulic braking system, and of the type comprising:
a body (12), defining a primary pressure chamber (14) and a secondary pressure chamber (16), separated by an axially movable piston (20), the so-called secondary piston;
means (24) for the hydraulic connection of the primary pressure chamber (14) with braking-force simulation means (26);
complementary moving and stationary means (28, 30) for the sealing of the hydraulic connection means (24), and borne by the secondary piston (20) and the body (12) respectively, the secondary piston (20) being axially movable between a rest position, in which the moving and stationary sealing means (28, 30) are spaced apart from each other, and a position in which said moving and stationary sealing means (28, 30) are cooperating with each other; and
complementary moving and stationary stops (34, 32) which cooperate with each other so as to define the rest position of the secondary piston (20) and which are borne by the secondary piston (20) and the body (12), respectively,
characterised in that the relative axial position of the moving and stationary sealing means (28, 30) is adjusted, when the secondary piston (20) is in its rest position, by an adjustment of the axial position of the stationary stop (32) inside the body (12).

2. The Process according to claim 1 for the adjustment of a master cylinder of the type comprising a stationary pin (32, 32ₙ, 32ₚ) extending substantially transversely to the travel direction of the secondary piston (20) in an elongate cavity (34) provided in said piston (20), the stationary and moving stops being defined by complementary contact areas of the stationary pin (32) and of the elongate cavity (34) respectively, and the pin (32, 32ₙ, 32ₚ) being accommodated inside a cylindrical hole provided in the body (12), having an axis substantially transverse to the travel direction of the piston (20) and called the reference axis (Y), characterised in that the axial position of the stationary stop inside the body (12) is adjusted through the adjustment of the distance of the contact area of the pin (32, 32ₙ, 32ₚ) relative to the reference axis (Y).

3. The process according to claim 2, characterised in that the distance of the contact area of the pin (32) relative to the reference axis (Y) is adjusted by means of a batch (L) of at least two pins (32ₙ, 32ₚ), each of them having a general form of revolution with a portion (42) for a contact with the moving stop (34), and extending into at least one centering end (44) received inside the hold-down hole, the diameters (Dₙ, Dₚ) of the contact portions (42) being different from a pin to another one whereas the diameters (D) of the centering ends (44) are identical for both pins or all of them.

4. The process according to claim 3, characterised in that:
the master cylinder is fitted with a pin (32ₙ) belonging to the batch and called the reference pin;
the stroke of the secondary piston (20) is measured between its rest position and the position in which the moving and stationary sealing means (28, 30) are cooperating with each other, such stroke being called the dead stroke (C);
the value of the measured dead stroke is compared with a desired predetermined value;
the reference pin (32ₙ) is replaced by another pin (32ₚ), which minimizes the difference between the measured and desired values of the dead stroke.

5. The process according to claim 4, characterised in that the diameter of the contact portion of the reference pin (32ₙ) is the smallest in the batch (L) so as to ensure a maximal dead stroke.

6. The process according to claim 2, characterised in that the distance of the contact area of the pin (32) relative to the reference axis (Y) is adjusted through a rotation, about said reference axis (Y), of a portion (42) of such pin (32), exhibiting a contour, for a contact with the moving stop (34), evoluting about the reference axis (Y) like an eccentric or a cam.

7. The process according to claim 6, characterised in that:
the stroke of the secondary piston (20) is measured between its rest position and the position in which the moving and stationary sealing means (28, 30) are cooperating with each other, such stroke being called the dead stroke (C);
the value of the measured dead stroke is compared with a desired predetermined value;
the pin (32) is moved about the reference axis (Y) till it reaches an angular position, zeroing the difference between the measured and desired values of the dead stroke, such position being called the adjusted position.

8. The process according to claim 7, characterised in that, prior to measuring the dead stroke of the secondary piston (20), the pin (32) is set in a predetermined angular position about the reference axis (Y), such position being called the pre adjustment position, in which the dead stroke is maximal.

9. The process according to claim 5, characterised in that, once the pin (32) has been moved to its adjusted position, such pin (32) is locked in position in the hold-down hole, in particular through the fixing of one end of the pin inside the hold-down hole.

10. The process according to claims 9, characterised in that, as regards the measurement of the dead stroke of the piston:
the secondary piston (20) is set in its rest position;
the primary pressure chamber (14) is supplied with pressure gas, more particularly air;
the secondary piston (20) is moved to the position in which the moving and stationary sealing means (28, 30) cooperate with each other;
the closing of the connection means (24) is detected through a pressure change in the braking-force simulation means (26).

11. The process acrording to claim 10 further includes a batch (L) of pins (32ₙ, 32ₚ) for the implementation of the process.

12. The process according to claim 6 further includes a hatch (L) of pin (32ₙ, 32ₚ) for the implementation of the process.

13. A tandem master cylinder for an electrohydraulic braking system, and of the type comprising:
a body (12), defining a primary pressure chamber (14) and a secondary pressure chamber (16), separated by an axially movable piston (20), the so-called secondary piston;
means (24) for the hydraulic connection of the primary pressure chamber (14) with braking-force simulation means (26); complementary moving and stationary means (28, 30) for the sealing of the hydraulic connection means (24), and borne by the secondary piston (20) and the body (12) respectively, the secondary piston (20) being axially movable between a rest position, in which the moving and stationary sealing means (28, 30) are spaced apart from each other, and a position in which these moving and stationary sealing means (28, 30) are cooperating with each other; and
a pin (32) fixed inside a cylindrical hole (33) provided in the body (12), having an axis substantially transverse to the travel direction of the piston (20) and called the reference axis (Y), and
extending inside an elongate cavity (34) provided in the secondary piston (20),
the stationary pin (32) and the elongate cavity (34) comprising complementary contact areas defining complementary stationary and moving stops, which cooperate with each other so as to define the rest position of the secondary piston (20),
characterised in that the contact area of the stationary pin (32) is defined through a contour of said stationary pin (32), evoluting about the reference axis (Y) like an eccentric or a cam.

14. The master cylinder according to claim 13, characterised in that the pin (32) is fitted with means (46) for a fixing inside the hold-down hole (33).

15. The master cylinder according to claim 14, characterised in that the stationary sealing means comprise an annular bearing seat (30) provided in the body, and the moving sealing means comprise a O-ring (28), borne by the secondary piston (20) and intended for a cooperation with said bearing seat (30).

16. The master cylinder according to claim 15, characterised in that the elongate cavity (34) communicates with a brake-fluid supply chamber (18), called the secondary supply chamber, the secondary piston (20) being provided with a passage (36) connecting up the secondary supply chamber (18) and the secondary pressure chamber (16), and closable by a valve (22).

17. Te master cylinder according to claim 16, characterised in that the valve (22) is fitted with a control stem (38), extending through the passage (36) provided in the secondary piston, and intended for a cooperation with the pin (32) so as to keep the valve (22) in the open position.
